(19) United States
(12) Patent Application Publication
(10) Pub. No.: US 2026/0128698 A1
(43) Pub. Date: May 7, 2026

(54) VARIABLE FREQUENCY DRIVE (VFD) CABLE EVALUATION

(71) Applicant: Southwire Company, LLC, Carrollton, GA (US)

(72) Inventor: Steven R. Wetzel, Cambridge, WI (US)

(21) Appl. No.: 19/369,859

(22) Filed: Oct. 27, 2025

Related U.S. Application Data
(60) Provisional application No. 63/712,506, filed on Oct. 27, 2024.

(51) Int. Cl. H02P 23/14; H02K 5/22

(52) U.S. Cl. CPC H02P 23/14; H02K 5/225

(57) ABSTRACT

A system for providing Variable Frequency Drive (VFD) cable evaluation may be provided. The system may comprise a three phase VFD portion, a motor portion, and a cable assembly under test. The three phase VFD portion may comprise a three phase VDF, an Electromagnetic Compatibility (EMC) plate connected to the three phase VDF, a three phase VFD portion shield plate, a first shield plate connector, and a first VFD cable that connects the three phase VDF to the first shield plate connector. The motor portion may comprise a motor portion shield plate, a second shield plate connector, a first EMC gland, a second VFD cable that connects the first EMC gland to the second shield plate connector, a terminal box, and a motor. The cable assembly under test may be disposed between the three phase VFD portion and the motor portion.

### RELATED APPLICATION

Under provisions of 35 U.S. C. § 119(e), Applicant claims the benefit of U.S. Provisional Application No. 63/712,506, filed Oct. 27, 2024, which is incorporated herein by reference.

### BACKGROUND

A ground loop is caused by the interconnection of electrical devices that results in multiple paths to ground, thereby forming closed conductive loops through the ground connections. A common example may comprise two electrical devices each connected to a mains power outlet by a three-conductor cable and plug containing a protective ground conductor for safety. When signal cables are connected between both devices, the shield of the signal cable is typically connected to the grounded chassis of both devices. This forms a closed loop through the ground conductors of the power cords, which are connected through the building wiring. In the vicinity of electric power wiring there may be stray magnetic fields, particularly from utility lines oscillating at 50 or 60 hertz. These ambient magnetic fields passing through the ground loop may induce a current in the loop by electromagnetic induction.

### BRIEF DESCRIPTION OF THE FIGURES

The accompanying drawings, which are incorporated in and constitute a part of this disclosure, illustrate various embodiments of the present disclosure. In the drawings:

FIG. 1 shows a system for providing Variable Frequency Drive (VFD) cable evaluation;

FIG. 2 shows a system for providing VFD cable evaluation;

FIG. 3 shows a system for providing VFD cable evaluation; and

FIG. 4 shows a method for providing VFD cable evaluation.

### DETAILED DESCRIPTION

### OVERVIEW

A system for providing Variable Frequency Drive (VFD) cable evaluation may be provided. The system may comprise a three phase VFD portion, a motor portion, and a cable assembly under test. The three phase VFD portion may comprise a three phase VDF, an Electromagnetic Compatibility (EMC) plate connected to the three phase VDF, a three phase VFD portion shield plate, a first shield plate connector, and a first VFD cable that connects the three phase VDF to the first shield plate connector. The motor portion may comprise a motor portion shield plate, a second shield plate connector, a first EMC gland, a second VFD cable that connects the first EMC gland to the second shield plate connector, a terminal box, and a motor. The cable assembly under test may be disposed between the three phase VFD portion and the motor portion.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Embodiments of the disclosure may provide a portable system that may be easily carried into customer sites or other locations to evaluate the performance of various cable types, lengths, termination methods, and attached accessories used in a variable frequency drive system. Embodiments of the disclosure may include a current probe and a digital oscilloscope to compare motor shaft currents (or other currents) flowing in the system. As the cables under test may be quickly swapped out, a variety of cables under test may be tested in a short time.

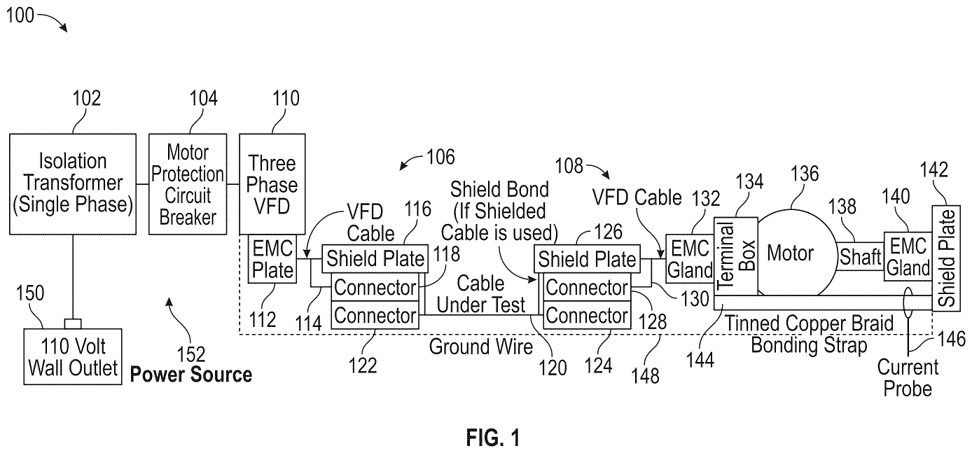

FIG. 1 shows a Variable Frequency Drive (VFD) cable evaluation system 100. As shown in FIG. 1, VFD cable evaluation system 100 may comprise an isolation transformer 102, a motor protection circuit breaker 104, a three phase VFD portion 106, and a motor portion 108. Three phase VFD portion 106 may comprise a three phase VFD 110, an Electromagnetic Compatibility (EMC) plate 112, a first VFD cable 114, a three phase VFD portion shield plate 116, and a first shield plate connector 118. VFD cable evaluation system 100 may test a cable assembly under test 120. Cable assembly under test 120 may comprise a cable under test first connector 122 at one end and a cable under test second connector 124 at the other end.

As further shown in FIG. 1, motor portion 108 may comprise a motor portion shield plate 126, a second shield plate connector 128, a second VFD cable 130, a first EMC gland 132, a terminal box 134, and a motor 136. Motor 136 may include a motor shaft 138. A second EMC gland 140 may connect motor shaft 138 to a motor shield plate 142. A bonding strap 144 may bond terminal box 134 to motor shield plate 142. A current probe 146 may read a current signal in bonding strap 144. A ground wire may ground three phase VFD 110 to motor shield plate 142. Bonding strap 144 may comprise, but is not limited to, a tinned copper braid bonding strap.

An energy source 150 may provide energy to isolation transformer 102. Isolation transformer 102 may be used to transfer electrical power from a source of Alternating Current (AC) power (e.g., energy source 150 comprising, for example, a 110 volt wall outlet) to VFD cable evaluation system 100 while isolating VFD cable evaluation system 100 from energy source 150, for example, for safety reasons or to reduce transients and harmonics. Motor protection circuit breaker 104 may be used to switch VFD cable evaluation system 100 on and off and may protect VFD cable evaluation system 100 from overcurrent. Motor protection circuit breaker 104 may be stand alone as shown in FIG. 1 or may be incorporated in three phase VFD 110 for example. Taken together, isolation transformer 102, motor protection circuit breaker 104, and energy source 150 may be considered power source 152.

Three phase VFD 110 may comprise an AC motor drive that may control speed and torque of motor 136 by varying the frequency of the input signal. Depending on its topology, it may control the associated voltage or current variation. When motor protection circuit breaker 104 is closed (or on), three phase VFD 110 may drive motor 136 through cable assembly under test 120. Motor 136 may comprise a three phase motor. Three phase VFD 110 may convert single phase power from energy source 150 to three phase power in order to drive motor 136.

EMC plate 112 may be deployed on three phase VFD 110. First VFD cable 114 may be connected between EMC plate 112 of three phase VFD 110 and first shield plate connector 118 associated with three phase VFD portion shield plate 116.

First VFD cable 114 may comprise three phase conductors, a ground, and may be shielded. One end of first VFD cable 114's shield may be bonded to EMC plate 112 and the other end of first VFD cable 114's shield may be bonded to three phase VFD portion shield plate 116. The three phase conductors and the ground of first VFD cable 114 may be terminated at first shield plate connector 118. EMC plate 112 or a similar accessory may be used to bond first VFD cable 114's shield to a Protective Earth (PE) ground of three phase VFD 110.

Cable assembly under test 120 may comprise three phase conductors and a ground, and may or may not be shielded, and may or may not incorporate intermediate termination and or conditioning accessories. One end of the three phase conductors and the ground of cable assembly under test 120 may be terminated at cable under test first connector 122 and the other end of the three phase conductors and the ground of cable assembly under test 120 may be terminated at cable under test second connector 124. If cable assembly under test 120 may comprise a shield, one end of cable assembly under test 120's shield may be bonded to three phase VFD portion shield plate 116 and the other end of cable assembly under test 120's shield may be bonded to Motor portion shield plate 126. Three phase VFD portion shield plate 116 and motor portion shield plate 126 may allow a low impedance at a high frequency bonding of one cable shield to another that may isolate the bonding from ground. Cable assembly under test 120 may comprise a shielded or non-shielded cable connected to at least one of a junction box, a disconnect, a filter, or a reactor and then connected to another shielded or unshielded cable for example.

First EMC gland 132 may be deployed on terminal box 134 of motor 136. An EMC gland may comprise a device that protects electrical equipment from electromagnetic interference (EMI). Second VFD cable 130 may be connected between first EMC gland 132 and second shield plate connector 128 associated with motor portion shield plate 126. Second VFD cable 130 may comprise three phase conductors, a ground, and may be shielded. One end of second VFD cable 130's shield may be bonded to first EMC gland 132 and the other end of second VFD cable 130's shield may be bonded to motor portion shield plate 126. The three phase conductors and the ground of second VFD cable 130 may be terminated at second shield plate connector 128. First EMC gland 132 may bond the shield of second VFD cable 130 to terminal box 134. First EMC gland 132 or a similar accessory may be used to bond second VFD cable 130's shield to a PE ground of motor 136 through terminal box 134.

Accordingly, the power from three phase VFD 110 may pass through the three phase conductors and ground of first VFD cable 114 to first shield plate connector 118. When cable under test first connector 122 of cable assembly under test 120 is connected to first shield plate connector 118, the power may pass through cable assembly under test 120 to cable under test second connector 124. When cable under test second connector 124 of cable assembly under test 120 is connected to second shield plate connector 128 the power from three phase VFD 110 may pass through the three phase conductors and ground of second VFD cable 130 to terminal box 134 of motor 136. Consequently, the power from three phase VFD 110 may feed motor 136 causing motor shaft 138 to turn. A load may or may not be placed on motor shaft 138.

When cable assembly under test 120 comprises a shield, a shield pathway may exist between three phase VFD 110 and motor 136 from EMC plate 112, through the shield of first VFD cable 114, to three phase VFD portion shield plate 116, through the shield of cable assembly under test 120, to motor portion shield plate 126, through the shield of second VFD cable 130, to first EMC gland 132 and terminal box 134, to motor 136. When cable assembly under test 120 is not shielded, the aforementioned shield pathway may not exist between three phase VFD 110 and motor 136.

Second EMC gland 140 may make electrical connection with motor shaft 138 while motor shaft 138 is turning due to motor 136 being power by three phase VFD 110 as described above. Motor shield plate 142 may be electrically connected to second EMC gland 140. Bonding strap 144 may be connected between motor shield plate 142 and terminal box 134 thus grounding or bonding a frame of motor 136 to motor shaft 138. Motor shield plate 142 may not bond cable shields but instead may bond motor shaft 138 to motor shield plate 142 that may then be bonded to motor 136's frame via bonding strap 144. Second EMC gland 140 or a similar accessory may be used to bond motor shaft 138 to a PE ground of motor 136 through motor shield plate 142.

Current probe 146 may be placed on bonding strap 144 to measure the current on motor shaft 138, if any. A digital oscilloscope may be connected to current probe 146 to see and measure the current signal on motor shaft 138 (e.g., 10's of MHz.). Also, while motor 136 is being powered by three phase VFD 110, EMI may be tested by an EMI meter at different points in VFD cable evaluation system 100.

Cable assembly under test 120 may be plugged into VFD cable evaluation system 100 by plugging cable under test first connector 122 into first shield plate connector 118 and plugging cable under test second connector 124 into second shield plate connector 128. Similarly, cable assembly under test 120 may be unplugged from VFD cable evaluation system 100 by unplugging cable under test first connector 122 from first shield plate connector 118 and unplugging cable under test second connector 124 from second shield plate connector 128. In this way many different types of cables may be used as cable assembly under test 120 and may be quickly tested and evaluated.

The aforementioned elements of VFD cable evaluation system 100 may be mounted in a portable case that may be transported by a person. The portable case may comprise wheels to aid in transportation. Isolation transformer 102 may in or out of the portable case. Accordingly, embodiments of the disclosure may provide a portable system that may be easily carried into customer sites or other locations to evaluate the performance of various cable types, lengths, termination methods, and attached accessories used in a variable frequency drive system. Current probe 146 and a digital oscilloscope may be used to compare motor shaft currents (or other currents) flowing in VFD cable evaluation system 100. As the cables under test may be quickly swapped out, a variety of cables assemblies under test may be tested in a short time.

When an unshielded cable (e.g., Thermoplastic High Heat-resistant Nylon-coated wire (THHN)) is used as cable assembly under test 120, the digital oscilloscope may show a large magnitude of current spikes passing through motor shaft 138. This large magnitude of current spikes passing through motor shaft 138 may cause premature bearing wear in motor 136 and unwanted current flows in the grounding grid of VFD cable evaluation system 100. Also, the EMI meter may show an inordinate amount of EMI in VFD cable evaluation system 100. However, when a shielded cable is used as cable assembly under test 120, the digital oscilloscope may show a reduced magnitude of current spikes passing through motor shaft. This reduced magnitude of current spikes passing through motor shaft may mitigate the aforementioned premature bearing wear in motor 136 and may mitigate the unwanted current flows in the grounding grid of VFD cable evaluation system 100. Also, the EMI meter may show low or no EMI in VFD cable evaluation system 100 with the shielded cable as cable assembly under test 120 and the termination process described above.

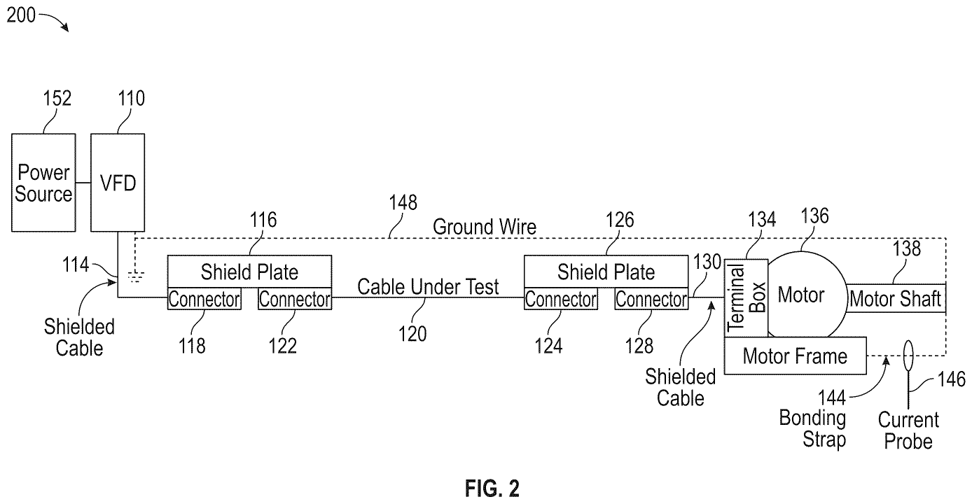

FIG. 2 shows a VFD cable evaluation system 200. As shown in FIG. 2, VFD cable evaluation system 200 may be similar to VFD cable evaluation system 100, however the embodiment shown in FIG. 2 illustrates that embodiments of the disclosure are not limited to using EMC plates or EMC glands (i.e., EMC plate 112, first EMC gland 132, and second EMC gland 140). Similar accessories or structures may be used to provide bonding and embodiments of the disclosure are not limited to EMC plates or EMC glands.

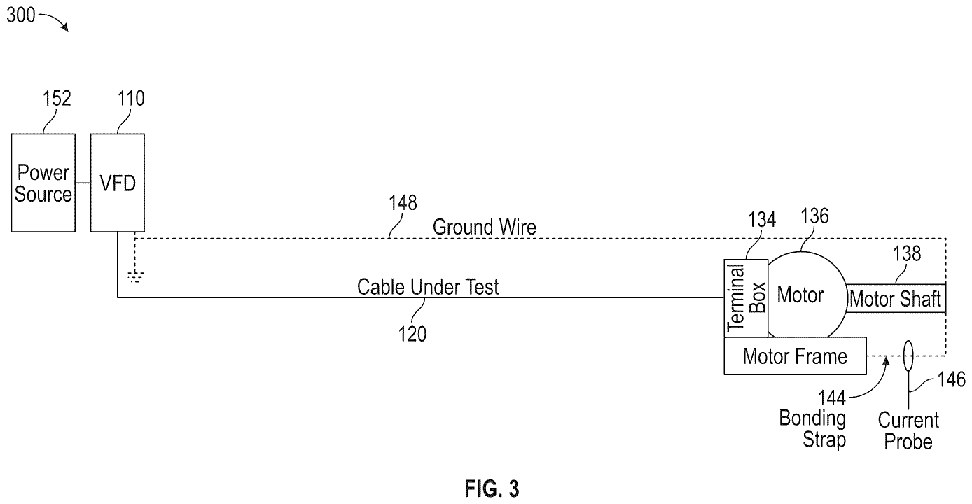

FIG. 3 shows a VFD cable evaluation system 300. As shown in FIG. 3, VFD cable evaluation system 300 may be similar to VFD cable evaluation system 200, however the embodiment shown in FIG. 3 illustrates that embodiments of the disclosure are not limited to using shield plates and connectors (i.e., VFD portion shield plate 116, motor portion shield plate 126, or motor shield plate 142). Similar accessories or structures may be used to allow a low impedance at a high frequency bonding of one cable shield to another that may isolate the bonding from ground and embodiments of the disclosure are not limited to using shield plates.

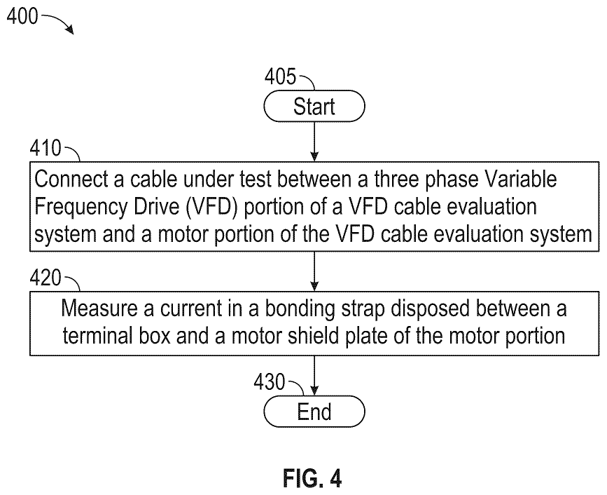

FIG. 4 is a flow chart setting forth the general stages involved in a method 400 consistent with embodiments of the disclosure for providing VFD cable evaluation. Method 400 may be implemented using VFD cable evaluation system 100 for providing VFD cable evaluation as described in more detail above with respect to FIG. 1. Ways to implement the stages of method 400 will be described in greater detail below.

Method 400 may begin at starting block 405 and proceed to stage 410 where an operator may connect cable assembly under test 120 between three phase VFD portion 106 of VFD cable evaluation system 100 and motor portion 108 of VFD cable evaluation system 100. For example, cable assembly under test 120 may be plugged into VFD cable evaluation system 100 by plugging cable under test first connector 122 into first shield plate connector 118 and plugging cable under test second connector 124 into second shield plate connector 128. Similarly, cable assembly under test 120 may be unplugged from VFD cable evaluation system 100 by unplugging cable under test first connector 122 from first shield plate connector 118 and unplugging cable under test second connector 124 from second shield plate connector 128. In this way many different types of cables may be used as cable assembly under test 120 that may be quickly tested and evaluated. The different cables used as cable assembly under test 120 may comprise shielded cables or unshielded cables for example.

From stage 410, where the operator connects cable assembly under test 120 between three phase VFD portion 106 of VFD cable evaluation system 100 and motor portion 108 of VFD cable evaluation system 100, method 400 may advance to stage 420 where the operator may measure a current in bonding strap 144 disposed between terminal box 134 and motor shield plate 142 of motor portion 108. For example, as stated above, second EMC gland 140 may make electrical connection with motor shaft 138 while motor shaft is turning due to motor 136 being power by three phase VFD 110 as described above. Motor shield plate 142 may be electrically connected to second EMC gland 140. Bonding strap 144 may be connected between motor shield plate 142 and terminal box 134 thus grounding or bonding a frame of motor 136 to motor shaft 138. Current probe 146 may be placed on bonding strap 144 to measure the current on motor shaft 138, if any. A digital oscilloscope may be connected to current probe 146 to see and measure the current signal on motor shaft 136. Also, while motor 136 is being powered by three phase VFD 110, EMI may be tested by an EMI meter at different points in VFD cable evaluation system 100.

When an unshielded cable (e.g., THHN) is used as cable assembly under test 120, the digital oscilloscope may show a large magnitude of current spikes passing through motor shaft 138. This large magnitude of current spikes passing through motor shaft 138 may cause premature bearing wear in motor 136 and unwanted current flows in the grounding grid of VFD cable evaluation system 100. Also, the EMI meter may show an inordinate amount of EMI. However, when a shielded cable is used as cable assembly under test 120, the digital oscilloscope may show a reduced magnitude of current spikes passing through motor shaft 138. This reduced magnitude of current spikes passing through motor shaft may mitigate the aforementioned premature bearing wear in motor 136 and may mitigate the unwanted current flows in the grounding grid of VFD cable evaluation system 100. Also, the EMI meter may show low or no EMI with the shielded cable and the termination process described above.

Method 400 may be repeated for different cable assemblies under test. Accordingly, embodiments of the disclosure may provide a portable system that may be easily carried into customer sites or other locations to evaluate the performance of various cable types, lengths, termination methods, and attached accessories used in a variable frequency drive system. Once the operator measures the current in bonding strap 144 disposed between terminal box 134 and motor shield plate 142 of motor portion 108 in stage 420, method 400 may then end at stage 430.

An embodiment consistent with the disclosure may comprise a system for providing Variable Frequency Drive (VFD) cable evaluation. The system may comprise a three phase VFD portion, a motor portion, and a cable assembly under test. The three phase VFD portion may comprise a three phase VDF, an Electromagnetic Compatibility (EMC) plate connected to the three phase VDF, a three phase VFD portion shield plate, a first shield plate connector, and a first VFD cable that connects the three phase VDF to the first shield plate connector. The motor portion may comprise a motor portion shield plate, a second shield plate connector, a first EMC gland, a second VFD cable that connects the first EMC gland to the second shield plate connector, a terminal box, and a motor. The cable assembly under test may be disposed between the three phase VFD portion and the motor portion.

An embodiment consistent with the disclosure may comprise a method for providing Variable Frequency Drive (VFD) cable evaluation. The method may comprise connecting a cable assembly under test between a three phase Variable Frequency Drive (VFD) portion of a VFD cable evaluation system and a motor portion of the VFD cable evaluation system. The method may then include measuring a current in a bonding strap disposed between a terminal box and a motor shield plate of the motor portion.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed IS:

1. A system comprising:
a three phase Variable Frequency Drive (VFD) portion wherein the three phase VFD portion comprises;
a three phase VDF,
an Electromagnetic Compatibility (EMC) plate connected to the three phase VDF,
a three phase VFD portion shield plate,
a first shield plate connector, and
a first VFD cable that connects the three phase VDF to the first shield plate connector;
a motor portion comprising;
a motor portion shield plate,
a second shield plate connector,
a first EMC gland,
a second VFD cable that connects the first EMC gland to the second shield plate connector,
a terminal box, and
a motor; and
a cable assembly under test disposed between the three phase VFD portion and the motor portion wherein the cable assembly under test comprises a cable under test first connector connected to the first shield plate connector and a cable under test second connector connected to the second shield plate connector wherein a current probe detects a current in a bonding strap disposed between a motor shield plate and the terminal box wherein a second EMC gland is disposed between the motor shield plate and a motor shaft of the motor.

2. The system of claim 1, further comprising an isolation transformer disposed between and energy source and the three phase VDF.

3. The system of claim 1, further comprising a motor protection circuit breaker disposed between the isolation transformer and the energy source.

4. The system of claim 1, further comprising a ground wire disposed between the motor shield plate and the three phase VDF.

5. The system of claim 1, further comprising an Electromagnetic Interference (EMI) meter configured to measure EMI on at least one location in the system.

6. The system of claim 1, further comprising an oscilloscope connected to the current probe to measure a current signal in the bonding strap.

7. The system of claim 1, wherein the cable assembly under test comprises a cable comprising a shield.

8. The system of claim 1, wherein the cable assembly under test comprises a shielded or non-shielded cable connected to at least one of a junction box, a disconnect, a filter, or a reactor and then connected to another shielded or unshielded cable.

9. The system of claim 1, wherein the shield is connected to the three phase VFD portion shield plate and the motor portion shield plate.

10. The system of claim 1, wherein the cable assembly under test comprises a cable not comprising a shield.

11. The system of claim 1, wherein the system is disposed in a container.

12. The system of claim 1, wherein the system is disposed in a container capable of being transported by a person.

13. A method comprising:
connecting a cable assembly under test between a three phase Variable Frequency Drive (VFD) portion of a VFD cable evaluation system and a motor portion of the VFD cable evaluation system; and
measuring a current in a bonding strap disposed between a terminal box and a motor shield plate of the motor portion.

14. The method of claim 13, further comprising terminating a shield bond of the cable assembly under test at a three phase VFD portion shield plate of the three phase VFD portion.

15. The method of claim 13, further comprising terminating a shield bond of the cable assembly under test at a motor portion shield plate of the motor portion.

16. The method of claim 13, further comprising providing power to a three phase VFD disposed in the three phase VFD portion from an isolation transformer.

17. The method of claim 16, wherein the isolation transformer is fed by an energy source.

18. The method of claim 13, wherein the system is disposed in a container.

19. The method of claim 13, wherein the system is disposed in a container capable of being transported by a person.

20. The method of claim 13, further comprising measuring Electromagnetic Interference (EMI) with an EMI meter on at least one location in the system.

21. An system comprising:
a three phase Variable Frequency Drive (VFD) portion wherein the three phase VFD portion comprises;
a three phase VDF,
a three phase VFD portion shield plate,
a first shield plate connector, and
a first VFD cable that connects the three phase VDF to the first shield plate connector;
a motor portion wherein the motor portion comprises;
a motor portion shield plate,
a second shield plate connector,
a second VFD cable that connects to the second shield plate connector,
a terminal box that connects to the second VFD cable, and
a motor; and
a cable assembly under test disposed between the three phase VFD portion and the motor portion wherein the cable assembly under test comprises a cable under test first connector connected to the first shield plate connector and a cable under test second connector connected to the second shield plate connector wherein a current probe detects a current between a motor shaft and a motor frame.

22. An system comprising:
a three phase Variable Frequency Drive (VFD) portion wherein the three phase VFD portion comprises a three phase VDF;
a motor portion wherein the motor portion comprises;
a terminal box, and
a motor; and
a cable assembly under test disposed between the three phase VFD portion and the motor portion wherein a current probe detects a current between a motor shaft and a motor frame.
